(19) United States
(12) Patent Application Publication
(10) Pub. No.: US 2006/0186673 A1
(43) Pub. Date: Aug. 24, 2006

(54) Latch assembly

(76) Inventor: Ming-Fuh Wong, Changhua County (TW)

Correspondence Address: BACON & THOMAS, PLLC, 625 SLATERS LANE, FOURTH FLOOR, ALEXANDRIA, VA, 22314, US

(21) Appl. No.: 11/062,798

(22) Filed: Feb. 23, 2005

(51) Int. Cl. E05C 1/10

(52) U.S. Cl. 292/175

(57) ABSTRACT

A latch assembly includes a casing having an accommodating chamber and a sliding track communicating to the outside, a latch bolt, which is moveably mounted in the sliding track and has a flange, a driving device, which is mounted in the accommodating chamber of the casing and has an actuating portion connectable to the flange of the latch bolt for moving the latch bolt along the sliding track, and a spring member provided between the latch bolt and the driving device for returning the latch bolt to an initial position.

### BACKGROUND OF THE INVENTION

1. Field of the Invention

The present invention relates to a latch assembly for locking a door and more particularly, to such a latch assembly, which is practical for use in any of a variety of doors.

2. Description of the Related Art

In most cities, public security is one of the greatest concerns to the residents. In order to protect the house against intruders, people may add an additional lock to the door panel to reinforce the locking security of the door. When a conventional lock, either a tubular lock or an advanced electronic chip lock, has a keyway at the outer side for the insertion of the key to unlock the lock. However, a thief can unlock a lock having a keyway exposed to the outside by inserting a tool into the keyway to move the internal locking mechanism. A thief can unlock an electronic chip lock by means of the use of a computer to decode the code and a tool for inserting into the keyway to move the internal locking mechanism of the electronic chip lock. Therefore, these conventional locks are still not highly reliable.

Further, if a lock is stuck in the door when locked, the resident will be unable to open the door with the key. In this case, the resident must hire a locksmith to detach the lock from the door or directly destruct the lock with a tool. Therefore, if a lock is damaged or fails during its use, it will cause a trouble to the resident.

### SUMMARY OF THE INVENTION

The present invention has been accomplished under the circumstances in view. It is the main object of the present invention to provide a latch assembly, which does not have a keyway exposed to the outside, thereby providing a reliable security.

It is another object of the present invention to provide a latch assembly, which can be equipped with different type or number of driving members to fit different requirements so that when one driving member failed the other driving member works to substitute for the damaged one, keeping normal functioning of the latch assembly.

To achieve these objects of the present invention, the latch assembly comprises a casing having an accommodating chamber and a sliding track communicating to the outside of the casing, a latch bolt moveably mounted in the sliding track and having a flange, a driving device, which is mounted in the accommodating chamber of the casing and has an actuating portion connectable to the flange of the latch bolt for moving the latch bolt, and a spring member provided between the latch bolt and the driving device for returning the latch bolt to an initial position.

In one embodiment of the present invention, the driving device is comprised of two electromagnets, each having a reciprocating rod provided with a pin for hooking on the flange of the latch bolt for moving the latch bolt. When one electromagnet failed, the other electromagnet is still workable, keeping normal functioning of the latch assembly.

### BRIEF DESCRIPTION OF THE DRAWINGS

FIG. 1 is a schematic drawing showing a latch assembly according to a first embodiment of the present invention.

FIG. 2 is an exploded view of the latch assembly according to the first embodiment of the present invention.

FIG. 3 is an exploded view of a latch assembly according to a second embodiment of the present invention.

FIG. 4 is a plain view of the latch assembly according to the second embodiment of the present invention.

FIG. 5 is similar to FIG. 4 but showing the latch bolt moved from the locking position to the unlocking position.

FIG. 6 is a cross-sectional view of the latch assembly according to the second embodiment of the present invention (the dead bolt excluded).

FIG. 7 is a schematic drawing of the second embodiment of the present invention, showing the handle pulled backwards, the latch bolt moved from the locking position to the unlocking position.

FIG. 8 is a plain view of an alternate form of the second embodiment of the present invention, showing the driving device formed of one single electromagnet.

FIG. 9 is a plain view of another alternate form of the second embodiment of the present invention, showing the driving device formed of three electromagnets.

FIG. 10A is a plain view of a latch assembly installed in a double-sliding sliding door according to a third embodiment of the present invention.

FIG. 10B is similar to FIG. 10A, but showing the latch of the spring latch inserted into the transverse latch hole of the casing.

FIG. 10C is similar to FIG. 10B but showing the latch bolt moved to the locking position and inserted through the through hole of the latch of the spring latch.

FIG. 11 is a plain view of a latch assembly according to a fourth embodiment of the present invention.

### DETAILED DESCRIPTION OF THE INVENTION

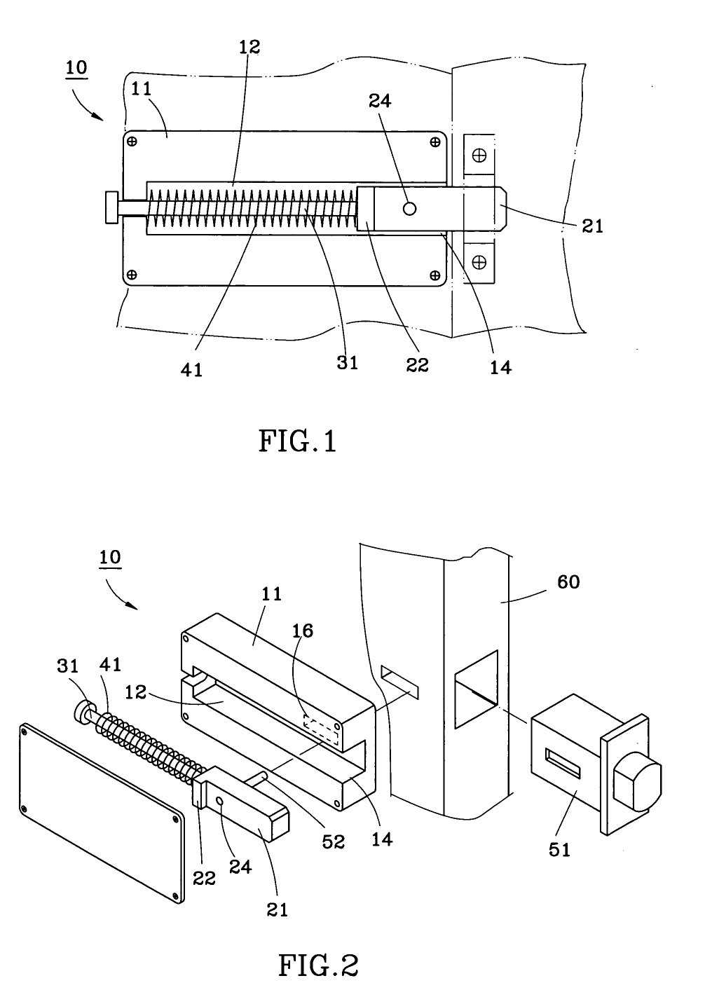

Referring to FIGS. 1 and 2, a latch assembly 10 in accordance with the first embodiment of the present invention is shown comprised of a casing 11, a latch bolt 21, a driving device 31, a spring member 41, and a dead bolt 51.

The casing 11 has an accommodating chamber 12, a sliding track 14 in communication with the outside, and a sliding slot 16 cut through the sliding track 14.

The latch bolt 21 is axially movably mounted in the sliding track 14, having a rear flange 22 and a locating hole 24 corresponding to the sliding slot 16 of the casing 11.

The driving device 31 is a pull rod, having an actuating portion, i.e. the end portion, connected to the rear flange 22 of the latch bolt 21. When imparting a pull force to the driving device 31, the latch bolt 21 will be moved with the driving device 31.

The spring member 41 is mounted on the latch bolt 21 and the driving device 31. When the applied pull force to the driving device 31 disappeared, the spring member 41 immediately returns the latch bolt 21 to its initial position, namely, the locking position.

The dead bolt 51 is provided at one side of the casing 11 for mounting in a door panel 60. A connecting rod 52 is inserted through the sliding slot 16 and press-fitted into the locating hole 24 to connect the dead bolt 51 to the latch bolt 21 for enabling the dead bolt 51 to be moved with the latch bolt 21 synchronously. Therefore, when pulling the pull rod 31, the dead bolt 51 will be moved with the latch bolt 21.

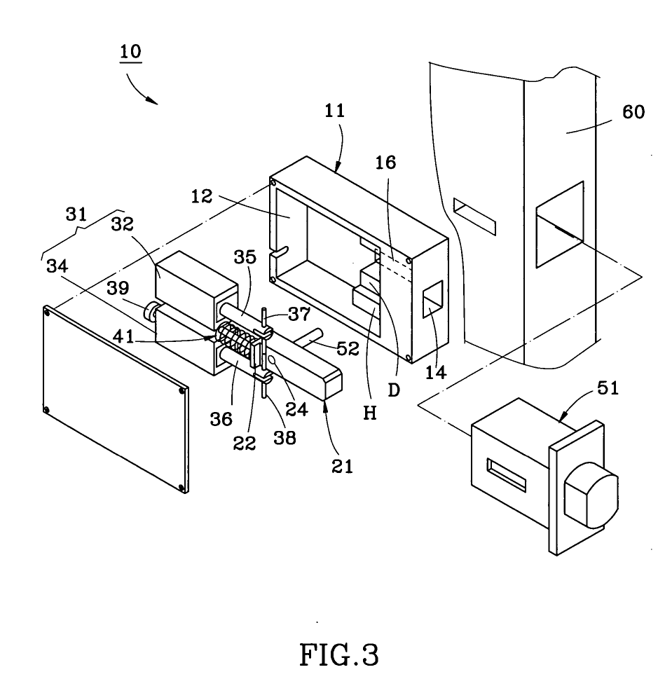

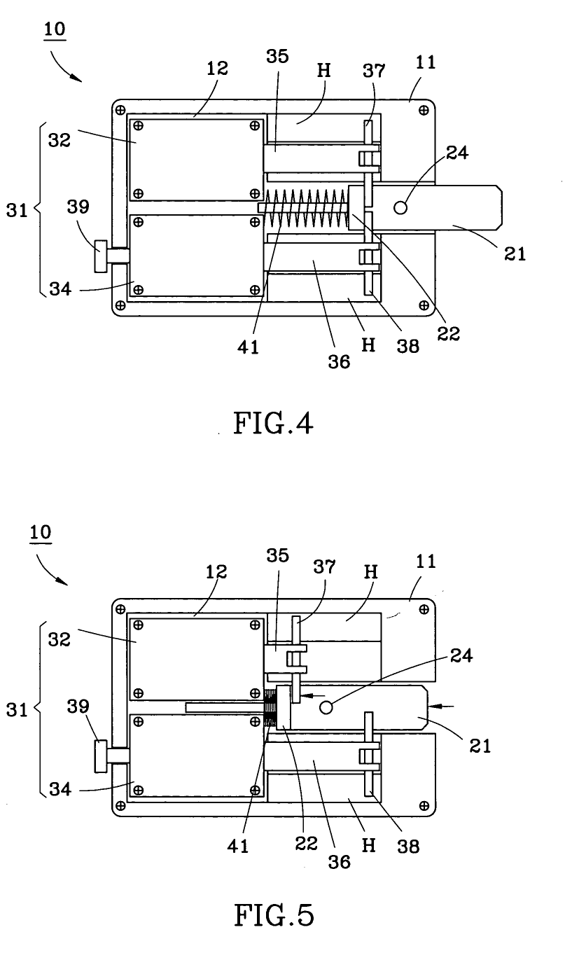

FIGS. 3 and 4 show a latch assembly 10 in accordance with the second embodiment of the present invention. According to this embodiment, the latch assembly 10 is comprised of a casing 11, a latch bolt 21, a driving device 31, a spring member 41, and a dead bolt 51.

The casing 11 has an accommodating chamber 12, a sliding track 14 in communication with the outside, and a sliding slot 16 cut through the sliding track 14.

The latch bolt 21 is axially movably mounted in the sliding track 14, having a rear flange 22 and a locating hole 24 corresponding to the sliding slot 16 of the casing 1.

The driving device 31 is comprised of a first electromagnet 32 and a second electromagnet 34. The first electromagnet 32 and the second electromagnet 34 are arranged in parallel inside the accommodating chamber 12 of the casing 11, each having a reciprocating rod 35 or 36 and a respective pin 37 or 38 fastened to the front end of the respective reciprocating rod 35 or 36 and hooked on the rear flange 22 of the latch bolt 21. Thus, each of the electromagnets 32 and 34 can move the latch bolt 21 in one direction. As shown in FIG. 5, when one electromagnet 32 is energized, it pulls the latch bolt 21 along the sliding track 14.

The spring member 41 is stopped between the electromagnets 32 and 34 and the rear flange 22 of the latch bolt 21. When the electromagnets 32 and 34 are off, the spring member 41 immediately returns the latch bolt 21 to its former position, namely, the locking position.

The dead bolt 51 is provided at one side of the casing 11 for mounting in a door panel 60. A connecting rod 52 is inserted through the sliding slot 16 and press-fitted into the locating hole 24 to connect the dead bolt 51 to the latch bolt 21 for enabling the dead bolt 51 to be moved with the latch bolt 21 synchronously. Therefore, when the electromagnets 32 and 34 are in action to pull the latch bolt 21, the dead bolt 51 will be moved with the latch bolt 21. Because the dead bolt 51 is mounted in the door panel 60, the locking action is reliable.

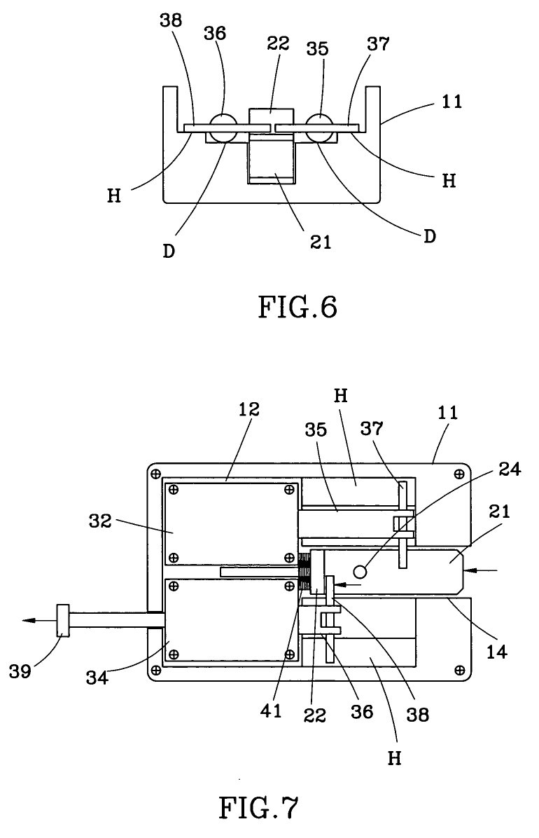

Referring to FIG. 6 and FIG. 3 again, the two opposite lateral sides of the sliding track 14 of the casing 11 have a stepped design, i.e., each lateral side of the sliding track 14 has a first step H adapted to support the pin 37 or 38, and a second step D adapted to support movement of the reciprocating rod 35 or 36. By means of the stepped design, the latch bolt 21 can be moved smoothly along the sliding track 14.

Further, the first and second electromagnets 32 and 34 are controllable by a remote controller or electronic means (such as chip induction, fingerprint scanner or any of a variety of wireless transmission techniques). As stated, the latch assembly 10 uses two electromagnets 32 and 34 for selectively moving the latch bolt 21. When one electromagnet 32 or 34 failed, the other electromagnet 34 or 32 can still work, keeping normal functioning of the latch assembly 10.

Referring to FIG. 7 and FIG. 3 again, a handle 39 is connected to the rear end of the reciprocating rod 36 of one electromagnet 34. A person inside the house can pull the handle 39 with the hand to move the latch bolt 21 backwards from the locking position to the unlocking position. When released the hand from the handle 39, the spring member 41 immediately returns the latch bolt 21 to its former position, namely, the locking position.

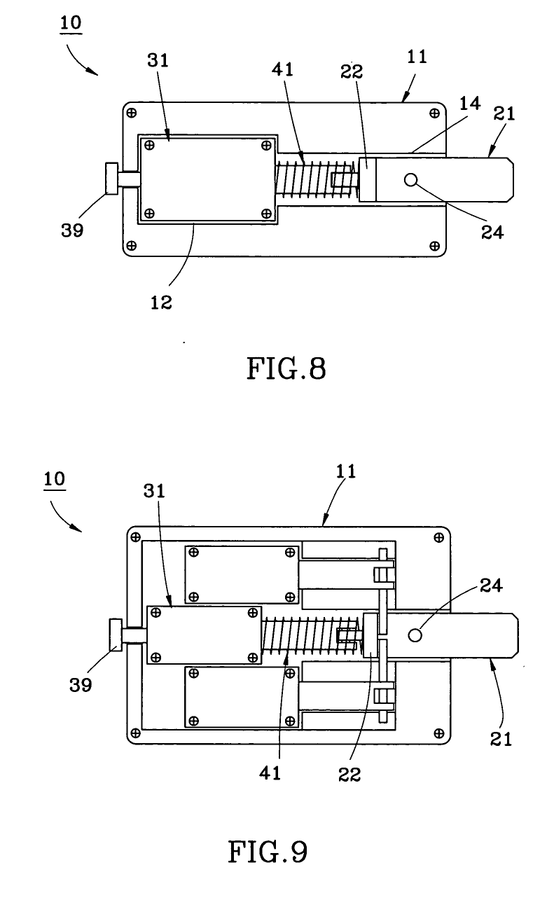

Further, subject to different requirements, different type or number of the driving device 31 may be attached. For example, FIG. 8 shows the driving device 31 formed of one single electromagnet; FIG. 9 shows the driving device 31 formed of at least three electromagnets.

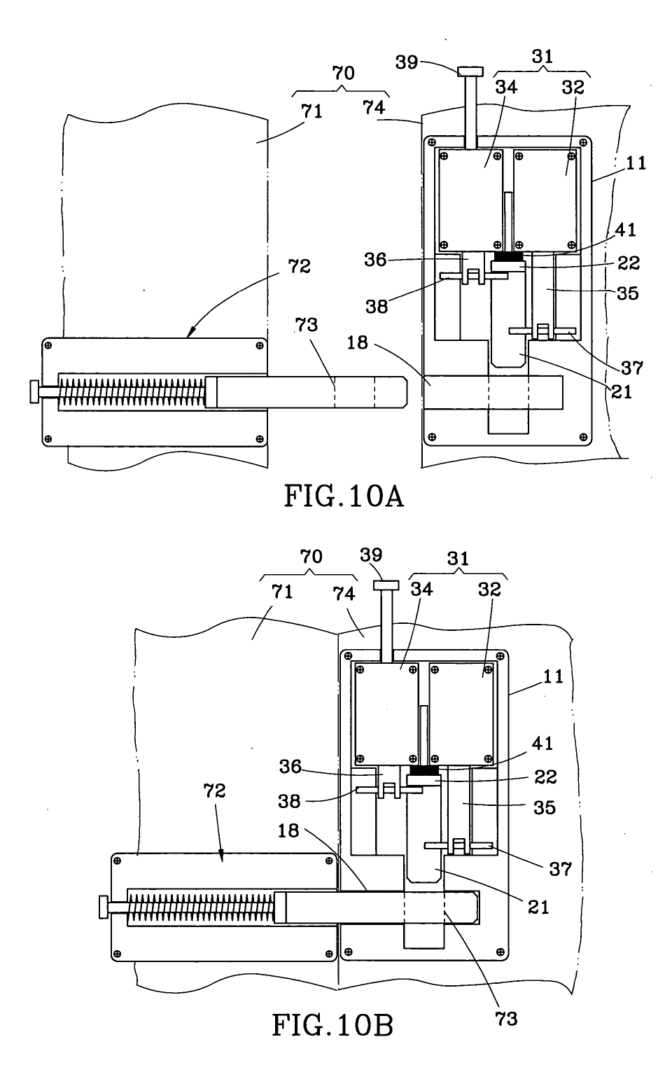

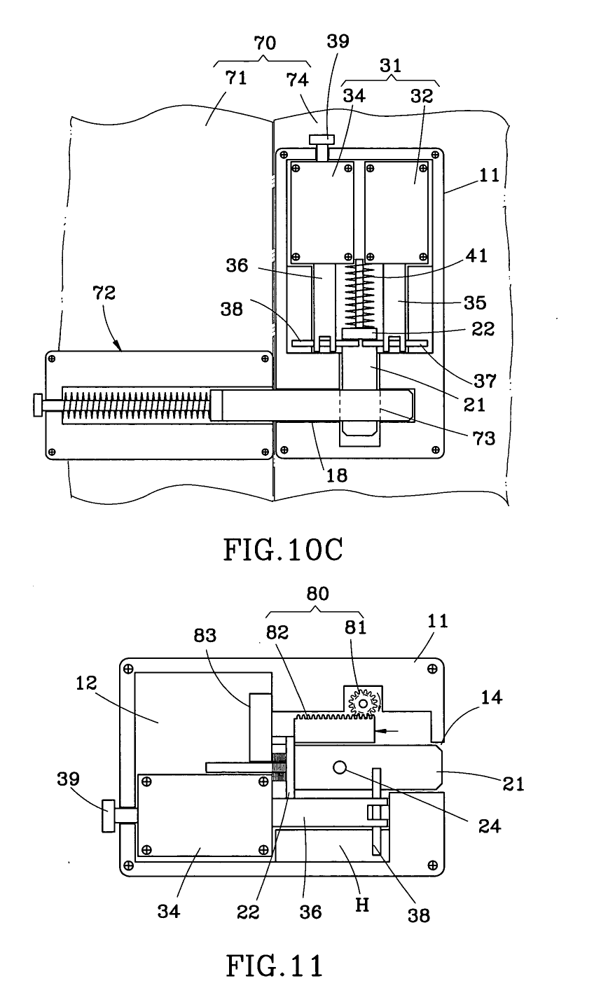

FIG. 10A shows a latch assembly used in a double-sliding sliding door 70 according to the third embodiment of the present invention. The double-sliding sliding door 70 comprises a left-side sliding door panel 71 and a right-side sliding door panel 74. In addition to the structure of the second embodiment of the present invention that is installed in the right-side sliding door panel 74 in this third embodiment, a spring latch 72 is mounted in the left-side sliding door panel 71. When closing the two sliding door panels 71 and 74, as shown in FIG. 10B, the latch bolt on which a transverse through hole 73 is provided will be forced into a transverse latch hole 18 in the casing 11. When moving the latch bolt 21 from the unlocking position to the locking position after the latch bolt of the spring latch 72 has been forced into the transverse latch hole 18 in the casing 11, the latch bolt 21 will insert through the transverse through hole 73 in the latch bolt to lock the spring latch 72 as shown in FIG. 10C, and therefore the two sliding door panels 71 and 74 of the double-sliding sliding door 70 are locked.

FIG. 11 is a plain view of a latch assembly according to the fourth embodiment of the present invention. According to this embodiment, the driving device of the latch assembly is comprised of an electromagnet 34 and a motor-driven rack assembly 80. The motor-driven rack assembly 80 is comprised of a gear 81, a rack 82, and a mini motor (not shown). The mini motor is used to rotate the gear 81, which is meshed with the rack 82. The reciprocating rod 36 of the electromagnet 34 has a pin 38 fixedly provided at the front end thereof for hooking on the rear flange 22 of the latch bolt 21. The rack 82 is adapted to stop the rear flange 22 of the latch bolt 21. When rotating the gear 81 to move the rack 82, the rack 82 will move the latch bolt 21 from the locking position to the unlocking position. Further, a micro switch 83 is mounted inside the accommodating chamber 12 at one end of the path of the rack 82 for turning off the mini motor when touched by the rack 82.

As indicated above, the invention has the following advantages:

1. A remote controller or any of a variety of electronic identification means can be designed for use with the latch assembly to control the operation of the electromagnet(s) and to further lock/unlock the door. Because no keyway is provided, the security of the present invention is enhanced.

2. The invention provides a spare electric driving device for emergency use. When the main electric driving device failed, the latch assembly can still function well.

3. The invention is practical for use in any of a variety of door structures, therefore the invention has an industrial value.

4. Different types or number of the driving device may be selectively used to fit different requirements.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A latch assembly comprising:
a casing having an accommodating chamber and a sliding track in communication with the outside of the casing;
a latch bolt movably mounted in said sliding track, said latch bolt having a flange;
a driving device mounted in said accommodating chamber of said casing, said driving device having an actuating portion connectable to said flange of said latch bolt for moving said latch bolt along said sliding track; and
a spring member provided between said flange of said latch bolt and said driving device for retuning said latch bolt to an initial position.

2. The latch assembly as claimed in claim 1, wherein said driving device further comprises a handle extending out of said casing for pulling by hand.

3. The latch assembly as claimed in claim 1, wherein said casing has a sliding slot in communication with said sliding track; said latch bolt has a locating hole; the latch assembly further comprises a dead bolt provided at one side of said casing, and a connecting rod inserted through said sliding slot of said casing and press-fitted into the locating hole of said latch bolt to connect said dead bolt to said latch bolt for synchronous movement.

4. The latch assembly as claimed in claim 1, wherein said driving device is comprised of at least two electromagnets arranged in parallel.

5. The latch assembly as claimed in claim 4, wherein each said electromagnet comprises a reciprocating rod, and a pin fixedly connected to said reciprocating rod for hooking on said flange of said latch bolt; said sliding track of said casing comprises a stepped structure for supporting and guiding movement of the reciprocating rod and the pin of each said electromagnet.

6. The latch assembly as claimed in claim 1, wherein said driving device comprises an electromagnet and a motor-driven rack assembly, said motor-drive rack assembly comprising a rack, a gear meshed with said rack, and a mini motor for rotating said gear so as to further move said rack.

7. The latch assembly as claimed in claim 6, wherein said electromagnet has a reciprocating rod and a pin at said reciprocating rod for hooking on said flange of said latch bolt; said rack of said motor-driven rack assembly is stopped at one side of said flange of said latch bolt for moving said latch bolt along said sliding track in one direction.
